(19) United States
(12) Patent Application Publication
(10) Pub. No.: US 2012/0211974 A1
(43) Pub. Date: Aug. 23, 2012

(54) COLOR-CODEABLE COUPLINGS FOR FIRE HOSES

(75) Inventor: Robert RICHARDSON, Cookshire (CA)

(73) Assignee: Mercedes Textiles Ltd., St. Laurent (CA)

(21) Appl. No.: 13/399,331

(22) Filed: Feb. 17, 2012

Related U.S. Application Data
(60) Provisional application No. 61/445,991, filed on Feb. 23, 2011.

(51) Int. Cl. F16L 35/00

(52) U.S. Cl. 285/93

(57) ABSTRACT

A fire hose coupling comprises a first coupler body having a first recessed portion that includes a first visual indication. The coupling also comprises a second coupler body adapted to be coupled to the first coupler body to form the coupling, the second coupler body having a second recessed portion that includes a second visual indication matching the first visual indication. Color-coded stickers or adhesive-backed high-visibility decals may be adhered to the recessed portions. The couplings may be recoded by adhering differently colored stickers. This technology enables firefighters to quickly and easily color-code their hoses for identification purposes. Because of the recesses, the color-coded stickers are substantially protected from abrasion or wear and tear.

### CROSS-REFERENCE TO RELATED APPLICATIONS

This is the first application filed for the present technology.

### TECHNICAL FIELD

The present technology relates generally to hose couplings and, in particular, to fire hose couplings.

### BACKGROUND

Fire hoses are coupled together with fire hose couplings. These couplings are well known in the art. Typically, one side of a coupling has an expansion ring to attach the coupling to its respective hose. On the other side of the coupling are usually a set of internal or external threads for fastening the coupling to complementary (external or internal) threads of another coupling. In addition to these male and female couplings, there also exist so-called “sexless couplings” such as the Storz-style couplings which employ shanks and clamps to attach to the hose and interconnecting lugs to fasten one coupling to another. The Storz-style couplings may include locking levers to lock these couplings together so as to preclude the couplings from becoming accidentally disconnected.

Fire hoses may be used to deliver a variety of different substances, including, for example, tank water, hydrant water, potable water, class A or class B foams, aqueous film-forming foam (AFFF type) or compressed air foam (CAF), etc. Identifying which hose is carrying which substance can be a challenge, particularly in the chaotic environment of a fire. In some cases, the ability to quickly identify which hose is carrying which substance may make the difference between life and death.

Furthermore, identifying which hose is going to which section of a building or to which crew can be a challenge where there are multiple hoses in action.

Moreover, it can be difficult to keep track of which hose belongs to which fire truck, station, battalion or unit.

Some rudimentary efforts have been made by firefighters to color code their hoses. However, improvised or makeshift solutions like colored tape applied to hoses has proven to be unsatisfactory, particularly since the tape is prone to coming loose and falling off or abrading off.

Painted or coated couplings are subject to damage by abrasion and require expensive maintenance to keep them visually professional. Also, these couplings are not changeable at the scene, nor are they easily changeable in the fire station.

Accordingly, a need remains for an improved fire hose coupling that addresses the above problems.

### SUMMARY

In general, the present invention provides a fire hose coupling having first and second coupler bodies each having recessed portions in which color-coded stickers, adhesive-backed colored films, or any other visually distinctive indicators may be affixed, attached or otherwise placed for the purposes of identifying or distinguishing the coupling and its hose from other such couplings and their respective hoses.

Different visual indications may be placed in the recessed portions to “recode” the couplings. For example, an existing sticker may be removed and a differently colored sticker may be adhered to the recessed portion. As another example, a differently colored sticker may be placed over top of an existing sticker. In either case, the color in the recessed portion is changed. The couplings are thus color-codeable or “color-recodeable”.

The visual indications may be provided by simple color stickers or light-reflecting adhesive-backed films that may be made of a super reflective, photo luminescent or phosfluorescent material. Other coatings, paints, tapes, films, etc. may be used as well.

Thus, a main aspect of the present invention is a fire hose coupling fire hose coupling having a first coupler body having a first recessed portion that includes a first visual indication. The coupling also has a second coupler body adapted to be coupled to the first coupler body to form the coupling, the second coupler body having a second recessed portion that includes a second visual indication matching the first visual indication.

Another aspect of the present invention is a method of providing a color-coded coupling to facilitate identification of fire hoses. The method entails providing a first fire hose attached to a first coupler body, wherein the first coupler body has a first recessed portion that includes a first visual indication, providing a second fire hose attached to a second coupler body, wherein the second coupler body adapted to be coupled to the first coupler body to form the coupling, the second coupler body having a second recessed portion that includes a second visual indication matching the first visual indication, and connecting the first coupler body to the second coupler body.

The details and particulars of these aspects of the invention will now be described below, by way of example, with reference to the attached drawings.

### BRIEF DESCRIPTION OF THE DRAWINGS

Further features and advantages of the present technology will become apparent from the following detailed description, taken in combination with the appended drawings, in which:

FIG. 1 is an isometric view of a pair of male and female threaded couplers each having a recessed color-coded portion in accordance with an embodiment of the present invention;

FIG. 2 is an isometric view of the couplers of FIG. 1 after they have been threaded together to form a coupling; and

FIG. 3 is an isometric view of a pair of male and female threaded couplers after having been recoded with a different color in accordance with another embodiment of the present invention.

It will be noted that throughout the appended drawings, like features are identified by like reference numerals.

### DETAILED DESCRIPTION

In general, the present invention provides a fire hose coupling having first and second coupler bodies in which are disposed recessed portions designed to receive visual indications for the purposes of identifying the hose to which the coupling is attached. The visual indications thus permit the couplings and their respective hoses to be color-coded. Furthermore, the visual indications may be changed, thus permitting the “color-recoding” of the coupling.

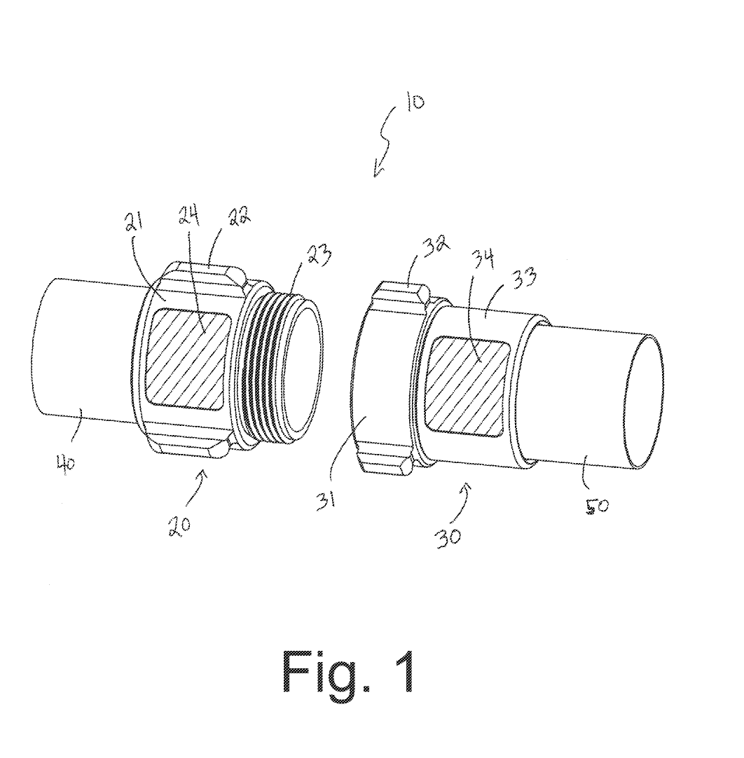

The coupler bodies forming the coupling may have machined recessed areas on the exterior surface of the coupler bodies, as shown by way of example in FIG. 1 to FIG. 3. Colored stickers or other visual indicators may then be adhered or other affixed to the recessed areas (or recessed portions). These visual indicators serve as labels or markers to indicate the color identity of the fire hose line. Many departments use colored couplings to identify the hose line for a special use. For example, a blue coupling would have foam in its hose.

With these stickers or other such visual indicators, one can not only identify the hose line and what substance it is carrying, but one can also change the visual indicator easily and quickly if required (even right at the fire scene). This enables firefighters to re-code their hoses to differentiate their hoses from the hoses of others. For example, at a large fire, there may be multiple units at the scene. If one unit is already using, for example, blue couplings, the unit arriving on the scene can quickly and easily recode their blue couplings by applying new stickers or other visual indicators to change the color of their couplings. This enables the colors of the couplings to be customized on the spot to permit easy identification and differentiation.

Recessing the outside surface of the coupling helps protect the label/sticker (or other visual indicator) from abrasion and peeling off.

FIG. 1 depicts first and second couplers 20, 30, each having a recessed color-coded portion in accordance with an embodiment of the present invention. As depicted by way of example in FIG. 1, the first coupler 20 and the second coupler 30 are adapted to be connected together to form a coupling 10.

In the particular embodiment depicted in FIG. 1, the coupling 10 is composed of a male threaded coupler 20 and a female threaded coupler 30. The male coupler 20 has an annular coupler body 21, radially extending lugs 22, male threads 23 and a recessed portion 24 that has a first visual indication (represented in the drawings by hatching). The female coupler 30 has a female-threaded socket 31 for receiving the male threads 23. The female coupler 30 includes radially extending lugs 32 and an annular body 33 having (in this example) a different outer diameter than the socket 31. The annular body 33 has a recessed portion 34 that includes a second visual indication that matches the first visual indication of the male coupler. The shape and location of the recessed portion is presented solely by way of example. It will therefore be appreciated that the recessed portion may be located elsewhere on the coupler body and the recessed portion may have a different shape. Furthermore, it will be appreciated that each coupler body may have a plurality of recessed portions.

As depicted by way of example in FIG. 1, the first recessed portion 24 may be disposed between adjacent lugs 22. The second recessed portion 34 may be disposed on the annular outer surface of the second coupler as shown in the figures. However, the second recessed portion 34 may also be disposed on the outer annular surface of the socket 31.

As depicted by way of example in FIG. 1, the male coupler 20 is attached to a first hose 40 whereas the female coupler 30 is attached to a second hose 50. The male and female couplers 20, 30 may be attached to their respective hose by any known mechanical means.

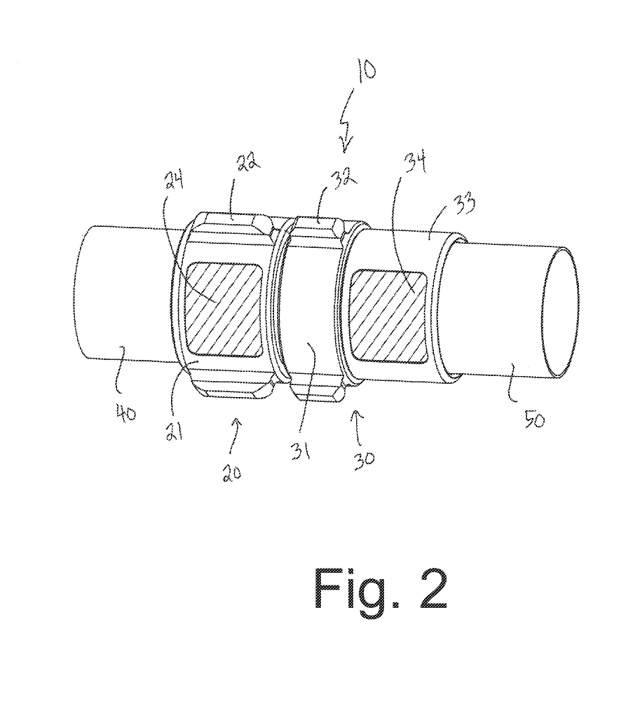

FIG. 2 is an isometric view of the couplers 20, 30 of FIG. 1 after they have been threaded together to form a coupling 10. The figure shows that the first recessed portion and the second recessed portion have the same size and shape and are aligned; however, this is solely for illustrative purposes as the first and second recessed portions may have different sizes or shapes and need not necessarily be aligned as shown in FIG. 2.

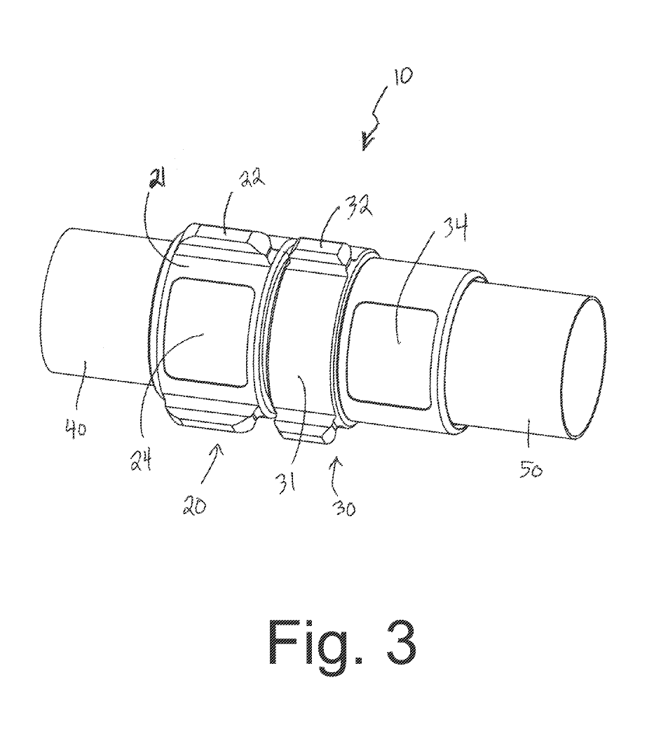

FIG. 3 is an isometric view of a pair of male and female threaded couplers 20, 30 after having been recoded with a different color in accordance with another embodiment of the present invention. The different color is represented in FIG. 3 by the solid white areas in the recessed portions 24, 34.

The first visual indication and the second visual indication in the recessed portions may be provided by matching colored stickers, by matching adhesive-backed super-reflective metal films, by matching photo-luminescent stickers, or by matching phosfluorescent stickers. Alternatively, coatings, paints, tapes, metallic films, etc. may be used for color-coding.

In another embodiment, the stickers may be barcode stickers. The barcode stickers may be scanned using a barcode scanner for inventory control and on-scene identification and differentiation. The barcode stickers may also have colors surrounding the black and white portion of the barcode to provide further color identification or differentiation. The term “barcode” is meant to encompass a broad range of optical machine-readable representations of data. In other words, stickers having any other optical machine-readable representations of data may also be affixed or adhered to the coupling such as, for example, stickers with QR code, Aztec Code, DataMatrix 2D, ShotCode, MaxiCode, EZcode, High Capacity Color Barcode, etc.

In another embodiment, the couplings may have an adhesive-backed RFID (radiofrequency ID) tag or adhesive patch with an embedded NFC (near-field communication) circuit to enable wireless detection and reading of identifying data associated with the coupling.

In another embodiment, the coupling may be a quarter-turn sexless coupling, such as a Storz coupling. Recesses may be provided in the annular body of the Storz coupling to accommodate visual indicators like stickers, decals, adhesive films, colored tape, paint, etc.

In summary, the coupling and method disclosed above confer advantages over the prior art. The recessed portions protect the visual indications, thus minimizing the likelihood that the visual indications will detach, abrade or wear off.

This new technology has been described in terms of specific examples, embodiments, implementations and configurations which are intended to be exemplary only. Persons of ordinary skill in the art will appreciate that obvious variations, modifications and refinements can be made without departing from the scope of the present invention. The scope of the exclusive right sought by the Applicant is therefore intended to be limited solely by the appended claims.

1. A fire hose coupling comprising:
a first coupler body having a first recessed portion that includes a first visual indication; and
a second coupler body adapted to be coupled to the first coupler body to form the coupling, the second coupler body having a second recessed portion that includes a second visual indication matching the first visual indication.

2. The coupling as claimed in claim 1 wherein the first visual indication and the second visual indication are provided by matching colored stickers.

3. The coupling as claimed in claim 1 wherein the first visual indication and the second visual indication are provided by matching adhesive-backed super-reflective metal films.

4. The coupling as claimed in claim 1 wherein the first visual indication and the second visual indication are provided by matching photo-luminescent stickers.

5. The coupling as claimed in claim 1 wherein the first visual indication and the second visual indication are provided by matching phosfluorescent stickers.

6. The coupling as claimed in claim 1 wherein the first coupler body comprises a plurality of equally spaced lugs extending radially outwardly from an annular outer surface of the body, and wherein the first recessed portion is disposed between an adjacent pair of lugs.

7. The coupling as claimed in claim 1 wherein the second coupler body comprises a plurality of equally spaced lugs extending radially outwardly from a female-threaded socket, and wherein the second recessed portion is disposed on an annular outer surface having a different outer diameter than the socket.

8. The coupling as claimed in claim 6 wherein the second coupler body comprises a plurality of equally spaced lugs extending radially outwardly from a female-threaded socket, and wherein the second recessed portion is disposed on an annular outer surface having a different outer diameter than the socket.

9. The coupling as claimed in claim 8 wherein the first visual indication and the second visual indication are provided by matching colored stickers.

10. The coupling as claimed in claim 1 wherein the first coupler body comprises a plurality of first recessed portions disposed between adjacent pairs of lugs extending radially outwardly from an annular outer surface of the first coupler body and wherein the second coupler body comprises a plurality of second recessed portions disposed on an outer annular surface of the second coupler body.

11. A method of providing a color-coded coupling to facilitate identification of fire hoses, the method comprising:
providing a first fire hose attached to a first coupler body, wherein the first coupler body has a first recessed portion that includes a first visual indication;
providing a second fire hose attached to a second coupler body, wherein the second coupler body adapted to be coupled to the first coupler body to form the coupling, the second coupler body having a second recessed portion that includes a second visual indication matching the first visual indication; and
connecting the first coupler body to the second coupler body.

12. The method as claimed in claim 11 wherein the first and second visual indications are provided by adhering colored stickers to the recessed portions.

13. The method as claimed in claim 12 further comprising recoding the color-coded coupling by adhering differently colored stickers to the recessed portions.
